(19) United States
(12) Patent Application Publication
(10) Pub. No.: US 2004/0183374 A1
(43) Pub. Date: Sep. 23, 2004

(54) Power supplies for electrical devices operating in vehicles

(76) Inventor: Krishnaswamy Ponmalai, Laguna Niguel, CA (US)

Correspondence Address: Eric K. Satermo, Registered Patent Agent, P.O. Box 19099, Irvine, CA, 92623-9099, US

(21) Appl. No.: 10/394,428

(22) Filed: Mar. 20, 2003

(51) Int. Cl. B60L 1/00

(52) U.S. Cl. 307/9.1

(57) ABSTRACT

A power supply provides power to an electrical device such as a motherboard operating in a vehicle. The motherboard may include a soft power switch input and a power source input and follow a power-up mode and a power-down mode. The power supply may include a power input for connecting to a battery of the vehicle and a switch input for connecting to an ignition of the vehicle. The power supply may also include a power output for connecting to the power source input of the motherboard and a switch output for connecting to the soft power switch input of the motherboard. A converter is connected between the power input and the power output for converting DC input power from the battery to DC output power for the motherboard. A controller is connected to the switch input and the switch output. The controller is programmed to cause the motherboard to initiate the power-up mode when the ignition of the vehicle is turned on and to initiate the power-down mode when the ignition of the vehicle is turned off.

### BACKGROUND OF THE INVENTION

1. Field of the Invention

The present invention relates to power supplies for electrical devices, particularly DC-to-DC power supplies, operating in battery-powered environments such as in vehicles. The invention also relates to electrical devices such as computers for operating in vehicles. In addition, the present invention relates to methodology for operating an electrical device such as a computer in a vehicle.

2. Description of the Related Art

Personal computers are designed to work in home and office environments on AC line power of 120 volts to 240 volts at 50 Hz to 60 Hz depending upon the power standard of the country. Computers utilize motherboards, examples of which include ATX, uATX, Flex-ATX, and ITX, and operate according to an operating system.

Computers typically have a on/off power switch configured as a push button located on a front panel for turning the computer on and off. This push-button switch is known as a “soft power” switch. Many computers also have a reset switch located on the front panel and a “hard power” toggle switch located on the back of the computer. AC power is provided by an AC inlet cable that plugs into a socket located on the back of the computer.

The operating systems of computers are often configured to initiate a number of modes with regard to power. These power modes may include a power-up mode, a power-down mode (or shutdown mode), a standby mode, and a hibernate mode. To turn a computer on, a user pushes the soft power switch, thereby initiating a power-up mode. To turn a computer off, a user may either push the soft power switch again, thereby shutting the computer off, or initiate a power-down mode. During operation, the AC power supply “shakes hands” with signals from the motherboard. These signals may include a “soft power switch” signal, a power supply-on (PS-on) signal, and a “power good” signal.

If a computer crashes or locks up, a user typically has to follow a number of steps to restore operation. For example, the user may to follow the following sequence:

1) shut power off by pressing the soft power switch;

2) wait for a period of time for the operating system to settle; and

3) initiate a power-up mode by pressing the soft power switch.

In most cases, this sequence restores operation. However, if power is not restored, a user may push the reset button to restore power. If the reset button is unsuccessful, then a user may follow the following sequence:

1) shut power off by either turning the hard power switch off or unplugging the AC inlet cable;

2) wait for a period of time (e.g., 10 seconds or more);

3) either turn the hard power switch on or plug in the AC inlet cable; and

4) initiate a power-up mode by pressing the soft power switch.

Each of the foregoing conventional power sequences may be adequate for computers operating in a home or office environment.

In addition to the home and office environments, computers are also utilized in vehicles where standard AC power is not available. Rather, vehicles utilize batteries that provide DC power, typically at 12 volts or 24 volts. Examples of such vehicles include automobiles, recreational vehicles, military vehicles, boats and ships, aircraft, construction equipment, trains, and electric carts. A number of electrical devices are configured to operate in vehicles, such as radios, CD players, and navigational systems. These devices typically turn on when the ignition system of the vehicle is activated (e.g., the ignition switch is turned on).

However, in a vehicle environment, conventional power sequences and operation for computers are not easily initiated and maintained, particularly for after-market installation. Factors effecting power and operation include weather (e.g., extreme temperature fluctuations) and location of the computer in the vehicle (i.e., to access the various elements to restore power).

These factors especially come into play when a vehicle computer (or similar electrical device) is an after-market installation. After-market installation of a computer in a vehicle is highly desirable for users who want to utilize various computerized functions, such as GPS mapping, e-mail, entertainment, Internet access, engine monitoring, and so on. However, conventional after-market installation of computers does not allow for automatic power up of the computer (e.g., analogous to a radio that is left on in a car).

### BRIEF SUMMARY OF THE INVENTION

A power supply provides power to an electrical device such as a motherboard operating in a vehicle. The motherboard may include a soft power switch input and a power source input and follow a power-up mode and a power-down mode. The power supply may include a power input for connecting to a battery of the vehicle and a switch input for connecting to an ignition of the vehicle. The power supply may also include a power output for connecting to the power source input of the motherboard and a switch output for connecting to the soft power switch input of the motherboard. A converter is connected between the power input and the power output for converting DC input power from the battery to DC output power for the motherboard. A controller is connected to the switch input and the switch output. The controller is programmed to cause the motherboard to initiate the power-up mode when the ignition of the vehicle is turned on and to initiate the power-down mode when the ignition of the vehicle is turned off.

Other features and advantages of the present invention will become apparent to those skilled in the art from a consideration of the following detailed description taken in conjunction with the accompanying drawings.

### BRIEF DESCRIPTION OF SEVERAL VIEW OF THE DRAWINGS

FIG. 1 is a block diagram of a power supply for an electrical device operating in a vehicle;

FIG. 2 is a flow chart illustrating a method of controlling the power provided to an electrical device;

FIG. 3 is a schematic view illustrating an embodiment of a power supply of the invention;

FIG. 4 is a schematic view illustrating another embodiment of a power supply connected to a motherboard;

FIG. 5 is a flow chart illustrating a method of installing a power supply and a motherboard in a vehicle;

FIG. 6 is a schematic view illustrating a computer of the invention;

FIG. 7 is a block diagram of computer of the invention;

FIG. 8 is a block diagram of a combination of a vehicle and a computer;

FIGS. 9A, 9B, and 9C are flow charts illustrating operational methodology of a controller of the invention;

FIG. 10 is a flow chart illustrating crash detection methodology of the invention;

FIG. 11 is a flow chart illustrating delayed shutdown methodology of the invention;

FIG. 12 is a flow chart illustrating low battery detection methodology of the invention;

FIG. 13 is a flow chart illustrating low battery filter methodology of the invention;

FIG. 14 is a flow chart illustrating cut-off stand-by power methodology of the invention; and

FIG. 16 is a flow chart illustrating temperature control methodology of the invention.

### DETAILED DESCRIPTION OF THE INVENTION

The present invention provides a number of technologies associated with the management of electrical devices operating in a battery-power environment. In setting forth the invention, the description hereunder centers around one of the many embodiments of the invention, namely, a power supply for a computer installed in a vehicle. However, the principles of the present invention are equally applicable to any number of other related embodiments in which power is provided to an electrical device with a given set of operating modes installed in or associated with a DC environment.

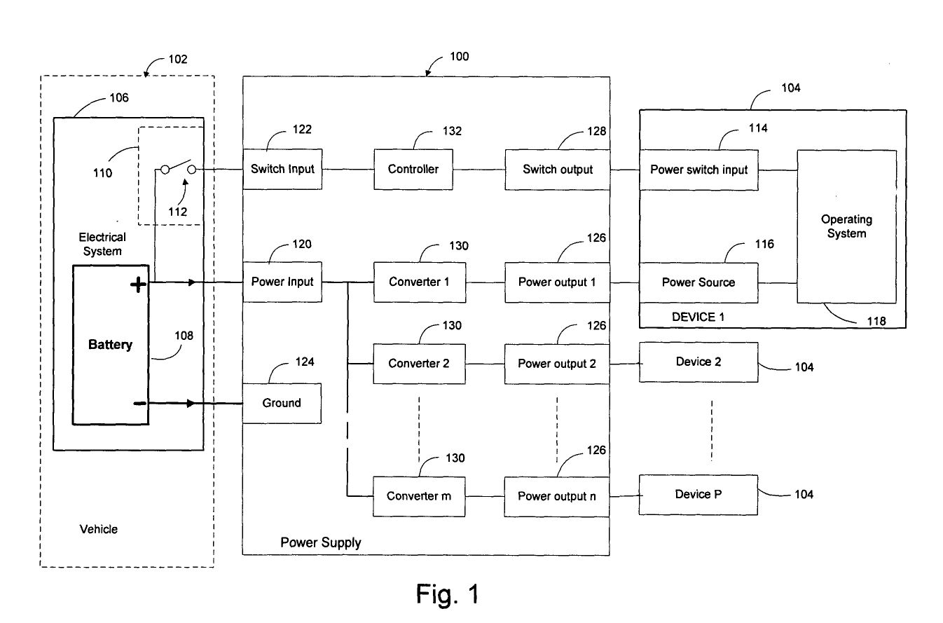

According to a number of embodiments of the invention, a power supply 100 as illustrated in FIG. 1 supplies power provided by a vehicle 102 to an electrical device 102. In this example, the vehicle 102 may include an electrical system 106 having a number of components, such as a battery 108 and an ignition system 110 with a switch 112. Also in this example, the electrical device 104 may include a power switch input 114 and a power source input 116. In a number of embodiments in which the electrical device 104 is a motherboard or a computer having an operating system 118, the device 104 may follow a power-up mode when turned on and a power-down mode when turned off.

Within this operating environment, the power supply 110 may have an input section that includes a power input 120 for connecting to the battery 108 and a switch input 122 for connecting to the ignition 110 of the vehicle 102. The power supply 110 may also include a ground 124 that may be connected to the ground of the electrical system 106. For an output section, the power supply 110 may include a power output 126 for connecting to the power source input 116 and a switch output 128 for connecting to the power switch input 114 of the device 104.

Functioning between the input and output sections is a converter 130 connected between the power input 120 and the power output 126 and a controller 132 connected between the switch input 122 and the switch output 128. The converter 130 converts DC input power from the battery 108 to DC output power for the electrical device 104.

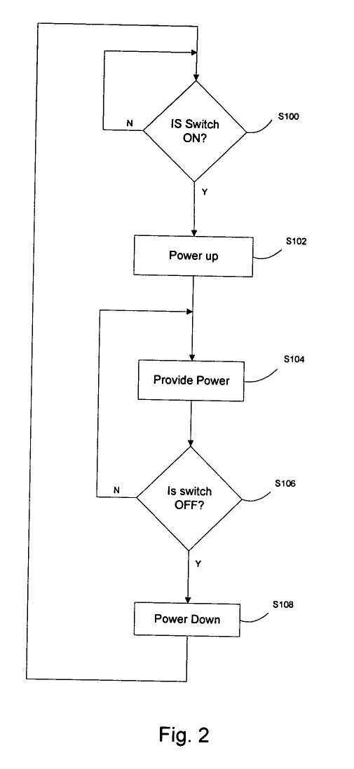

With additional reference to FIG. 2, when the ignition system 110 of the vehicle 102 is activated S100, the controller 132 is programmed to cause the electrical device 104 to follow the power-up mode S102, thereby turning on the device 104. In addition, the converter 130 provides DC output power S104 to the electrical device 104. When the ignition system 110 of the vehicle 102 is deactivated S106, the controller 132 is programmed to cause the electrical device 104 to follow the power-down mode S108, thereby turning off the device 104.

With continued reference to FIG. 1, in a number of embodiments the power supply 100 may include a plurality of converters 130 (i.e., converter 1, converter 2, . . . converter m) and a plurality of power outputs 126 (i.e., power output 1, power output 2, . . . power output n). In some of the embodiments, the number of converters 130 and outputs 126 may be the same.

Each of the converters 130 is connected between the power input 120 and one of the power outputs 126, converts DC input power from the battery 108 to DC output power, and provides the DC output power to the power output to which it is connected. In turn, a plurality of electrical devices 104 (i.e., device 1, device 2, . . . device p) may be connected to the power outputs 126.

In a number of embodiments, at least one of the converters 130 provides DC output power at a value that is different from the DC output power provided by the other converters 130. In addition, at least one of the converters 130 may provide DC output power at more than one level (i.e., at two different voltages).

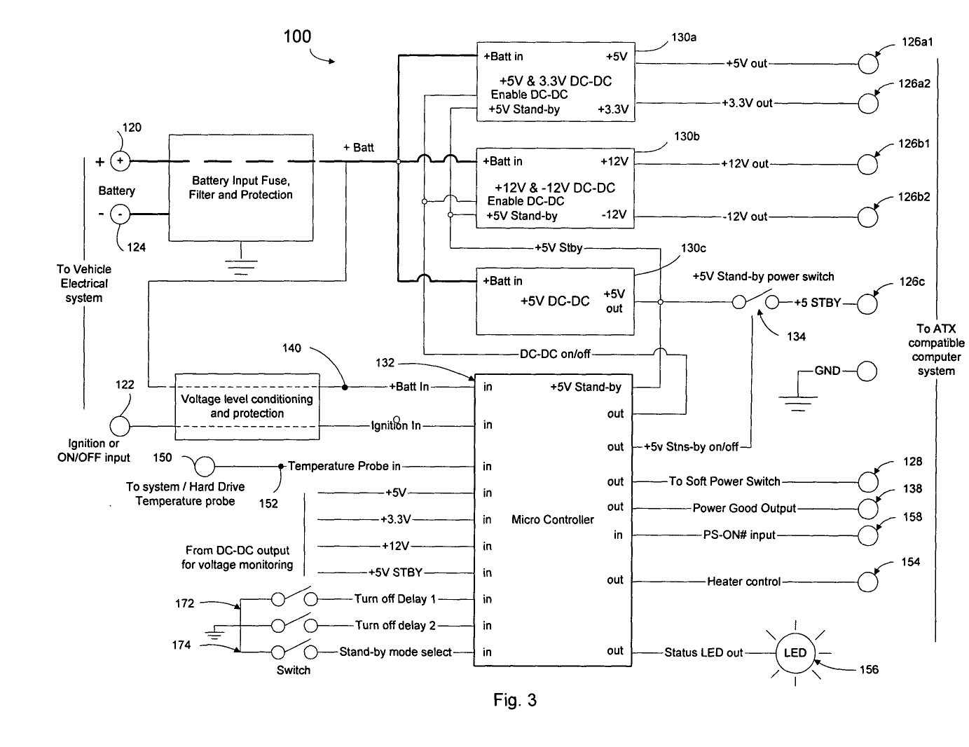

For example, in the embodiment shown in FIG. 3 in which the power supply 100 is configured to power an ATX-compatible motherboard, converter 130a provides DC output power at about +5 volts to power output 126a₁ and provides DC output power at about +3.3 volts to power output 126a₂. In addition, converter 130b provides DC output power at about +12 volts to power output 126b₁ and provide DC output power at about −12 volts to power output 126b₂. Also, converter 130c provides DC output power at about +5 volts to power output 126c.

As shown in FIG. 3, in a number of commercial motherboard embodiments, the power supply 100 may include a stand-by switch 134 connected to the controller 132 and between converter 130c and power output 126c, such that +5 volts of stand-by DC power is provided at output 126c. In this embodiment the controller 132 is configured to maintain +5 volts of stand-by power at output 126c when the ignition switch 112 (see FIG. 1) is turned off. The +5 volts of stand-by power may also be provided to controllers 130a and 130b, as well as to the controller 132.

Also as shown in FIG. 3, according to a number of embodiments, the controller 132 may be connected to each of the non-stand-by converters, i.e., converters 130a and 130b. Accordingly, depending upon certain criteria (described below), the controller 132 may enable and disable the converters 130a and 130b as required.

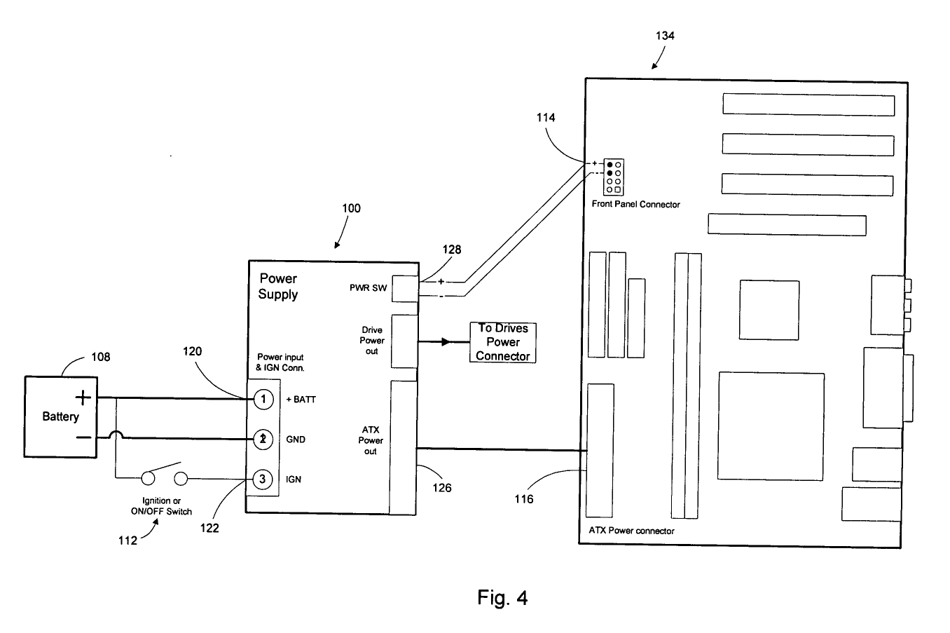

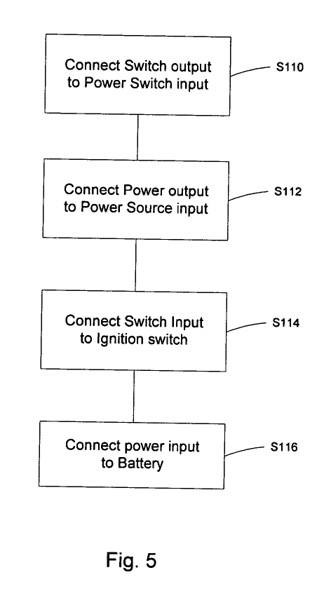

Continuing with the example of a commercial embodiment, the power supply 100 is shown in FIG. 4 connected to an ATX-compatible motherboard 136 in accordance with the methodology illustrated in FIG. 5. More specifically, a “soft power” switch input 114 of the motherboard 136 (for connecting to the soft power push-button switch on the front panel of a computer) is connected to the switch output 128 of the power supply 100 (step S1110). In addition, a power source input 116 of the motherboard 136 (i.e., the power connector) is connected to the power outputs 126a₂ and 126c providing +3.3 volts and +5 volts stand-by, respectively (step S112).

Further, the switch input 122 of the power supply 100 is connected to the ignition switch 112 (step S114) of a vehicle (e.g., either to the ignition terminal or to an accessory terminal of the electrical system). And the power input 122 of the power supply 100 is connected to the battery 108 of the vehicle (step S116). The power outputs 126a₁ and 126b₁ of the power supply 100 providing +5 volts and +12 volts, respectively, may be connected to a power connector of a disk drive.

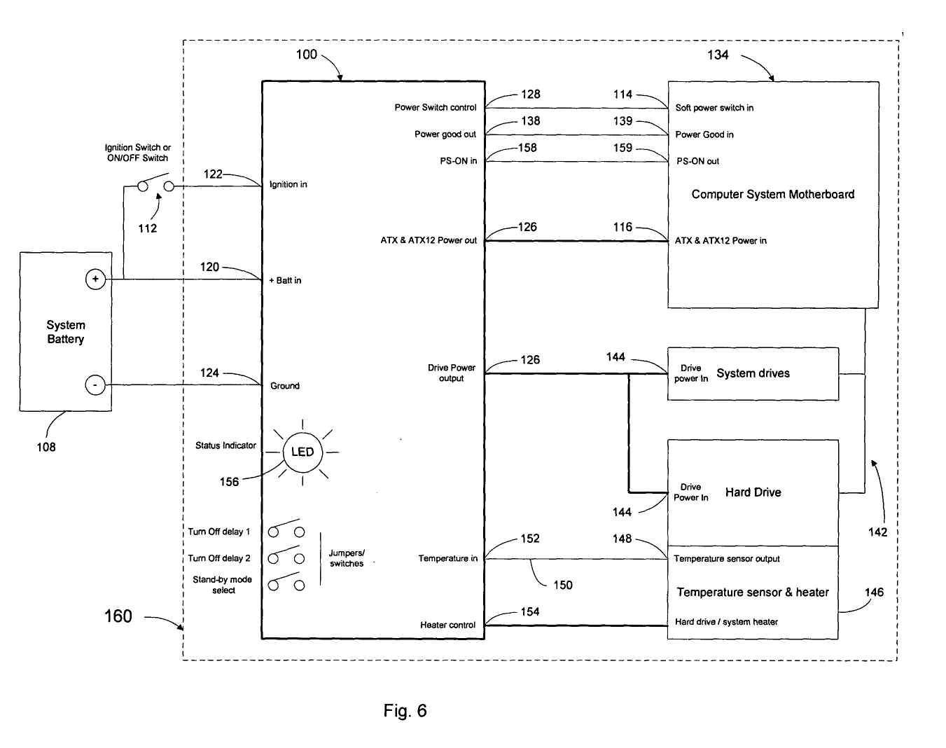

With continued reference to FIG. 3 and additional reference to FIG. 6, the power supply 100 may include a power-good output 138 connected to the controller 132, with the controller including power monitor input 140 connected to the battery 108 (e.g., to the power input 120). The motherboard may include a power-good input 139 connected to the power-good output 138. According to this embodiment, the controller 132 may be configured to monitor the condition of the DC input power and, if the DC input power meets a specification, send a power-good signal to the motherboard 136.

With continued reference to FIGS. 3 and 6, in a number of embodiments a disk drive 142 with one or more power inputs 144 may be connected to one or more of the power outputs 126 (as well as to the motherboard 134). The disk drive 142 may have a heater 146 and a temperature sensor 148. In this embodiment, the power supply 100 may include a temperature probe 150 connected to a temperature probe input 152 of the controller 132. The temperature probe 150 may also be connected to the temperature sensor 148 of the disk drive 142. In addition, the power supply 100 may also include a temperature control output 154 connected to the controller and to the heater 146 of the disk drive 142. In this embodiment, the controller 132 monitors the temperature of the disk drive 142 and activates the heater 148 when the temperature of the disk drive 142 falls below a threshold.

In other embodiments the power supply 100 may also include a signal output 156 connected to the controller 132. The signal output 156 may be a visual output such as a light-emitting diode (LED). The controller 132 activates the signal output 156 to indicating a status of the power supply 100, which will be discuss in more detail below. In still other embodiments, the power supply 100 may include a power supply-on input 158 connected to the controller 100 and to a power supply-on input 159 of the motherboard 134 for receiving a power supply-on (PS-on) signal from the motherboard 134, which features are also shown in FIGS. 3 and 6.

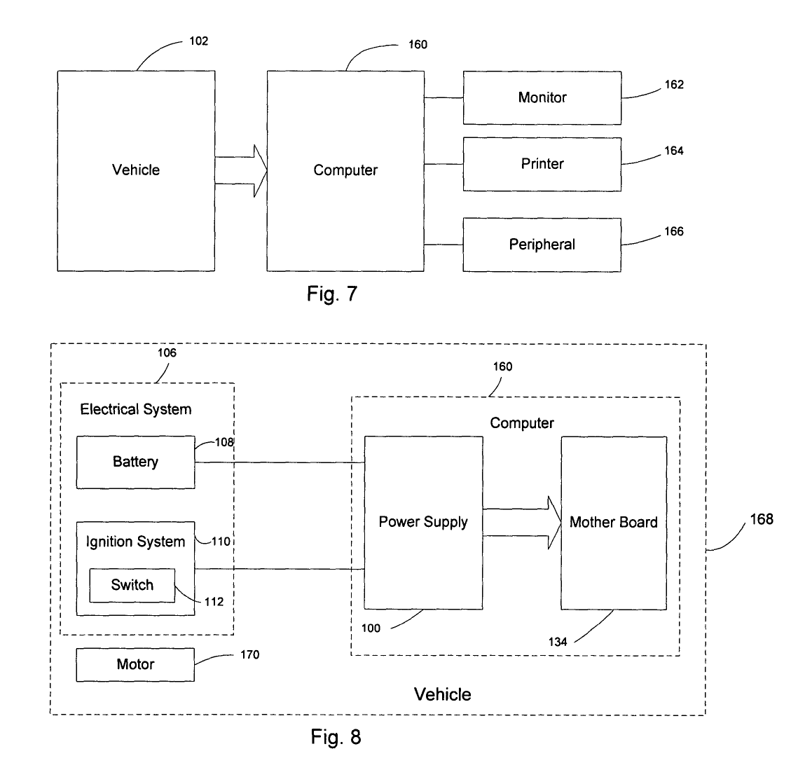

Rather than connecting the power supply 100 to the vehicle 102 and to an electrical device 104, the power supply 100 may be integrated with electrical device. For example, as shown in FIG. 6, a computer 160 of the invention includes the power supply 100 and the motherboard 134 integrated together as a single unit. The computer 160 therefore has a power input 120 for connecting to a battery 108 and a switch input 122 for connecting to the ignition switch 112 of the vehicle. The computer 160 may also include one or more disk drives 142 as discussed above, as well as a monitor 162, a printer 164, and known peripherals 166, as shown in FIG. 7.

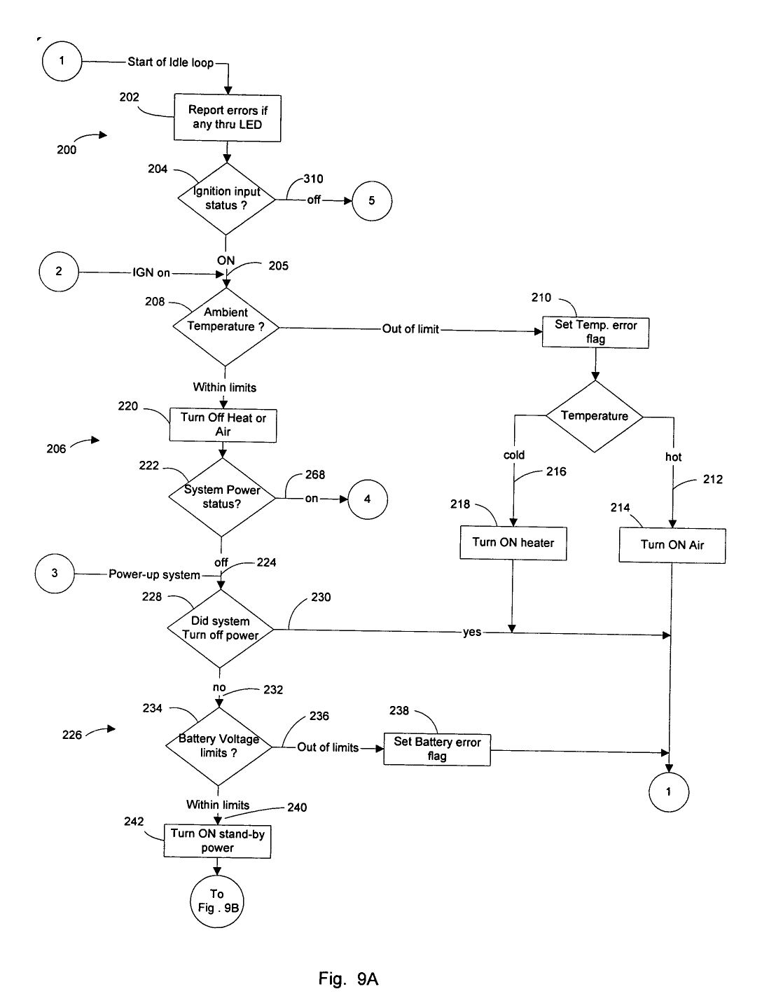

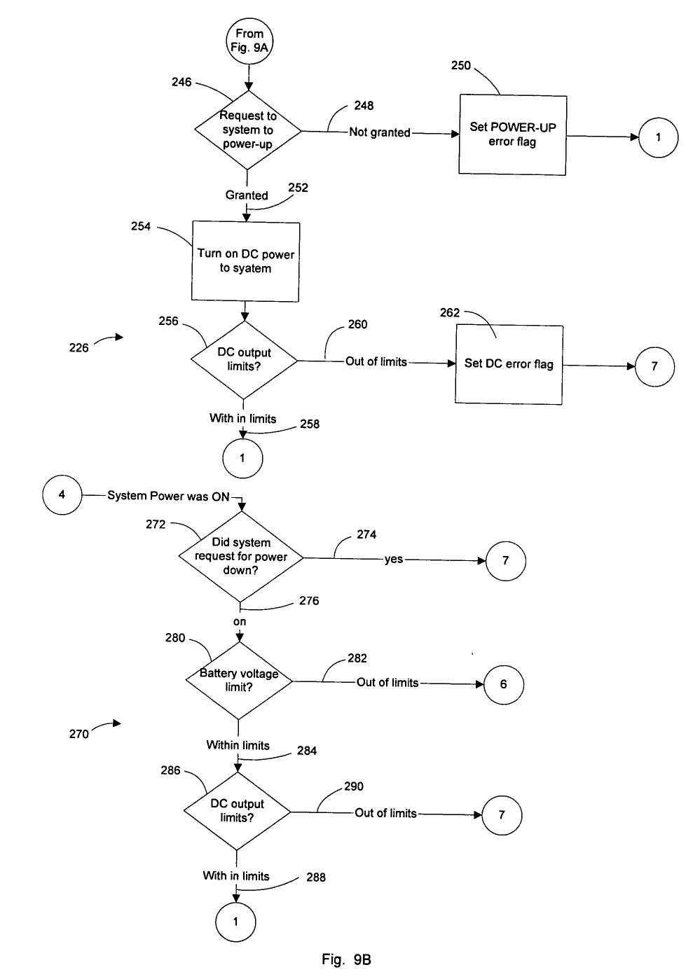

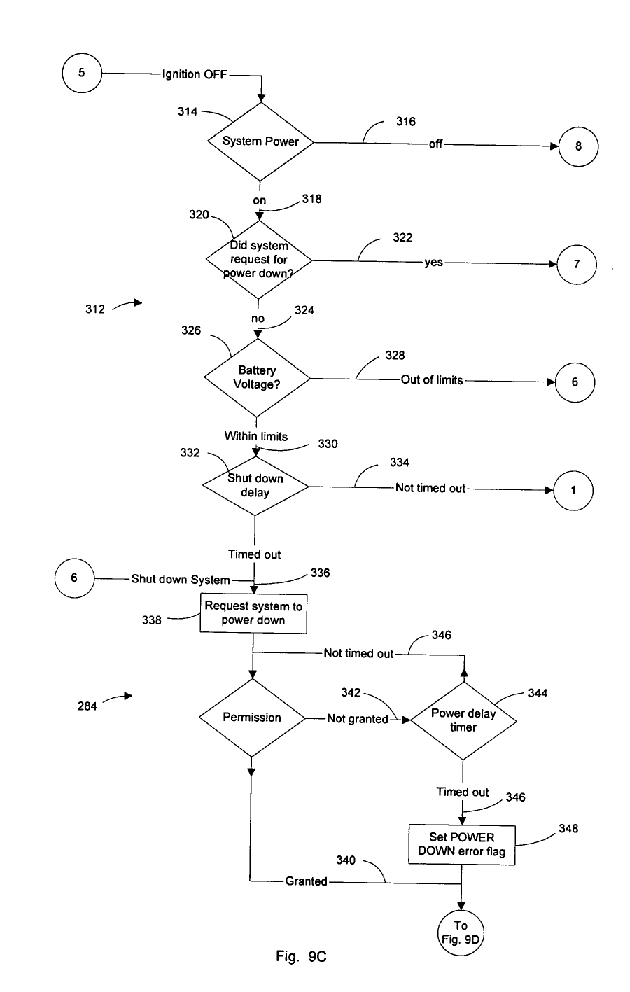

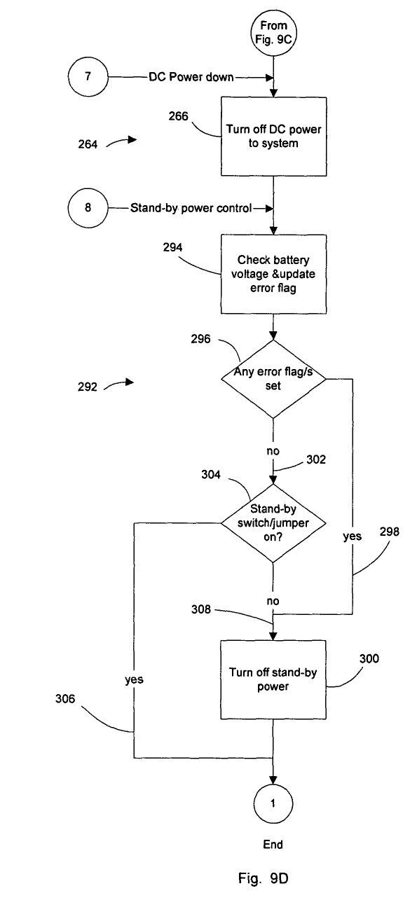

Referencing FIG. 9, according to other embodiments the computer 160 may be integrated with a vehicle 168 in which the power supply 100 is connected with the electrical system 106 of the vehicle. The vehicle 168 may be a fuel-power vehicle with a motor 170 and a conventional ignition system 110. Alternatively, the vehicle 168 may be an electric vehicle where the switch 112 of the electrical system 106 is an on/off switch. In addition to vehicular embodiments, the power supply 100 may be utilized on carts or trolleys with portable DC power sources, such as inventory carts, hospital carts, and so on.

Referencing FIG. 3, according to a number of other embodiments, the power supply 100 may include a plurality of turn-off delay switches 172 and a stand-by control switch 174, each of which is connected to an input of the controller 132. These switches will be discussed in more detail below.

In view of the foregoing description of the various hardware components of the invention, the operation of the controller 132 will now be provided with reference to FIGS. 9 to 15. In a number of embodiments the controller 132 is a microprocessor (e.g., an Atmel AVR-series microprocessor) operating in accordance with embedded firmware.

Referencing FIGS. 9A, 9B, and 9C, the controller 132 initially is in an idle loop 200 and may report any errors 202 that may be detected by enabling the signal indicator 156 (e.g., an LED). As illustrated at 204, the controller 132 monitors the ignition switch 112 (if installed in a motorized vehicle) or the on/off switch 112 (if installed in an electric vehicle).

If the switch 112 is on 205, then an ignition on sequence 206 is initiated. The controller 132 may monitor the ambient operating temperature 208. If the ambient operating temperature is out of a predetermined range or predetermined limits, then the controller 132 may enable a temperature error flag 210. If the ambient operating temperature exceeds an upper limit 212 (i.e., too hot), then the controller 132 may turn on air 214 (e.g., a cooling fan). If the ambient operating temperature falls below a lower limit 216 (i.e., too cold), then the controller 132 may turn on a heater 218. In either case, the operation of the controller 132 may then return to the idle loop 200. If the ambient operating temperature is within the predetermined range or limits, then the controller 132 may turn off the air or heat 220 (if operating) and may then monitor the system power 222 of the device 104 (i.e., through the power supply-on input 158 in FIG. 3).

If the system power is off 224, then the controller 132 may initiate a power-up sequence 226. The controller 132 may then determine whether or not the system or the device 104 turned off the power 228. If so 230, then the operation of the controller 132 may return to the idle loop 200. If not 232, then the controller 132 may determine whether or not the DC input power from the battery 108 is within predetermined limits 234 (e.g., 12 volts±a tolerance). If the DC input power is out of the predetermined limits 236, then the controller 132 may enable a battery error flag 238 (e.g., through the signal output 156) and return to the idle loop 200. If the DC input power is within the predetermined limits 240, then the controller 132 may turn on the stand-by power 242 (e.g., by activating the stand-by switch 134).

The controller 132 may then request the system or device 104 to power up 246. If the request is not granted 248, then the controller 132 may enable a “power up” error flag 250, with the operation of the controller 132 returning to the idle loop 200. If the request is granted 252, then the controller 132 may turn on the DC output power 254 to the device 104 (e.g., by enabling the converters 130). The controller 132 may then determine whether or not the DC output power is within predetermined limits 256. If so 258, the operation of the controller 132 may return to the idle loop 200. If not 260, then the controller 132 may set a DC error flag 262 and initiate a DC power-down sequence 264 (see FIG. 9C), which may include turning off the DC output power 266 to the system or device 104.

Returning to 222, if the controller 132 determines that the system power is on 268 during the ignition on sequence 206, then the controller 132 initiates a system power already on sequence 270 (see FIG. 9B). The controller 132 then determines whether or not the device 104 requested to be powered down 272. If so 274, the controller 132 initiates the DC power down sequence 264. If not 276, then the controller 132 may determine whether or not the DC input power from the battery 108 is within predetermined limits 280. If the DC input power is out of the predetermined limits 282, then the controller 132 may initiate a system shutdown sequence 284 (see FIG. 9C). If the DC input power from the battery 108 is within the predetermined limits 284, then the controller 132 may determine whether or not the DC output power is within predetermined limits 286. If so 288, the operation of the controller 132 may return to the idle loop 200. If not 290, then the controller 132 may initiate a DC power-down sequence 264 (see FIG. 9C).

After completing a DC power down sequence 264, the controller 132 may initiate a stand-by power control sequence 292 by initially checking the DC input voltage from the battery 108 and updating any error flag 294. The controller 132 determines whether or not any error flags are set 296 and, if so, turns off the stand-by power and returns to the idle loop 200. If there are no error flags set 302, then the controller determines whether or not the stand-by switch is on 304. If so 306, the operation of the controller 132 returns to the idle loop 200. If not 308, then the controller 132 turns off the stand-by power 300 and returns to the idle loop 200.

Returning to 204, if the ignition switch is off 310, then the controller 132 initiates an ignition off sequence 312. In this sequence, if the system power 314 is off 316, then the controller 132 initiates a stand-by power control sequence 292. If the system power 314 is on 318, then the controller determines whether the system 104 requested to be powered down 320. If so 322, then the operation of the controller 132 go to the DC power down sequence 264. If not 324, then the controller 132 determines whether or not the DC input power from the battery 108 is within limits 326. If not 328, the controller 132 initiates a system shut down sequence 284. If so 240, then the controller 132 determines whether or not the shutdown or turn-off delay is timed out 332. If not 334, then the operation of the controller 132 returns to the idle loop 200. If so 336, then the controller 132 initiates a system shutdown sequence 284.

In sequence 284, the controller 132 requests the system 104 to shutdown 338. If permission is granted 340, then the controller 132 initiates a DC power down sequence 264. If permission is not granted 342, then the controller 132 determines whether or not the shutdown delay is timed out 344. If not 346, the controller 132 continues to in a loop until permission is granted 340. If so 348, then the controller 132 sets a power-down error flag 348 and initiates a DC power down sequence 264.

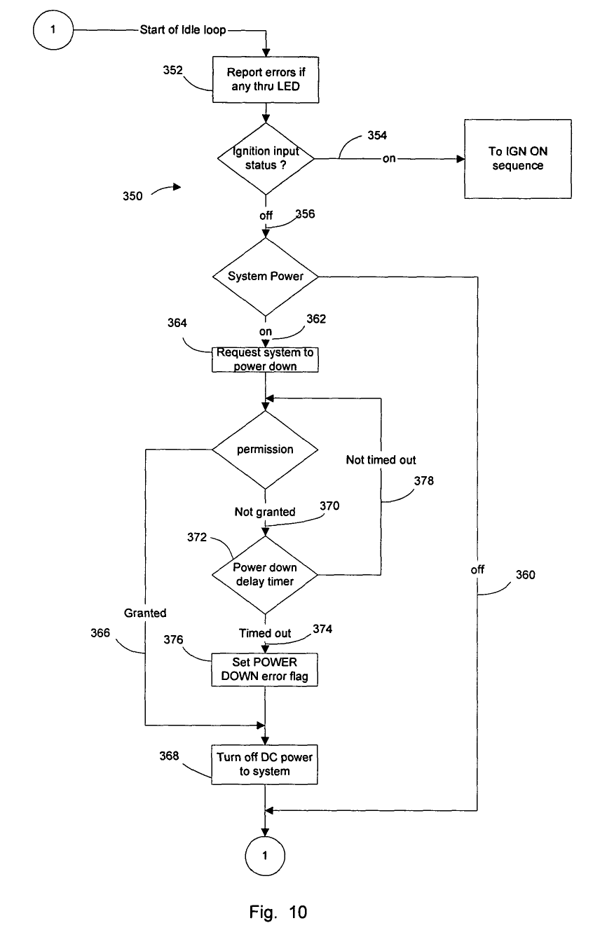

Referencing FIG. 10, in a number of embodiments the controller 132 may be configured to detect a crash or lock-up of the system 104. In this embodiment, the controller 132 initiates an idle loop 350 and reports any errors 352 through the signal output 156. Thereafter, if the ignition is on 354, then the controller 132 initiates a ignition on sequence 206. If the ignition is off 356, then the controller 132 determines whether or not the system power is off 358. If so 360, the operation returns to the idle loop 200. If not 362, the controller 132 requests the system 104 to power down 364. If permission is granted 366, the controller 132 turns off the DC power to the system 368 and returns to the idle loop 200. If permission is not granted 370, then the controller 132 determines whether the power down delay is timed out 372. If so 374, the controller 132 sets a power down error flag 376 and turns off the DC power to the system 368. If not 378, the controller 132 loops until either permission is granted 366 or the power down delay is timed out 374.

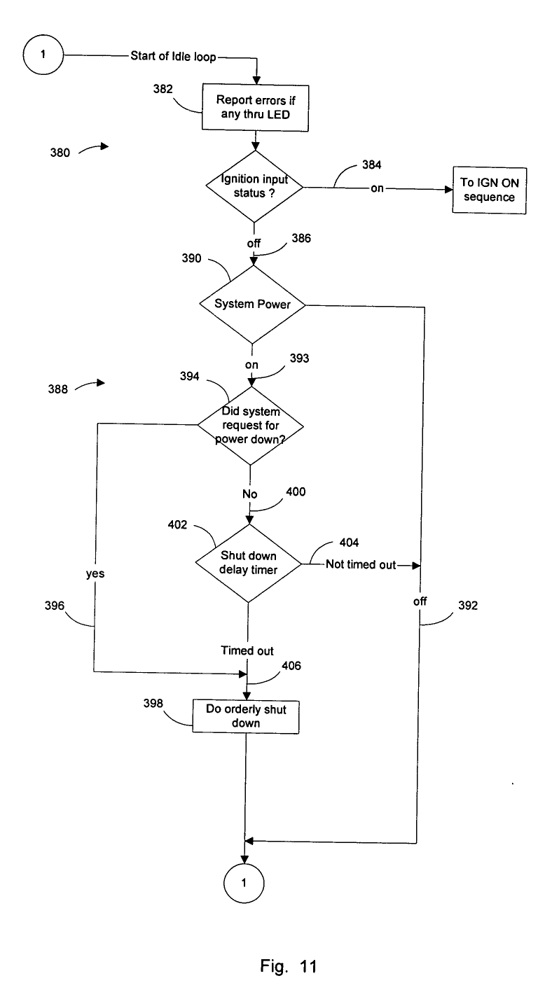

With reference to FIG. 11, in other embodiments the controller 132 may be configured in a delayed shutdown timer implementation. In this embodiment, the controller 132 initiates an idle loop 380 and reports any errors 382 through the signal output 156. Thereafter, if the ignition is on 384, then the controller 132 initiates a ignition on sequence 206. If the ignition is off 386, then the controller 132 initiates an ignition off sequence 388. Initially, the controller 132 determines whether or not the system power is off 358. If so 392, the operation returns to the idle loop 200. If not 393, the controller 132 determines whether or not the system requested to be power down 394. If so 396, then the controller 132 initiates an orderly shutdown 398 and returns to the idle loop 200. If not 400, then the controller 132 determines whether or not the shutdown delay is timed out 402. If not 404, the controller 132 returns to the idle loop 200. If so 406, the controller 132 initiates an orderly shutdown 398 and then returns to the idle loop 200.

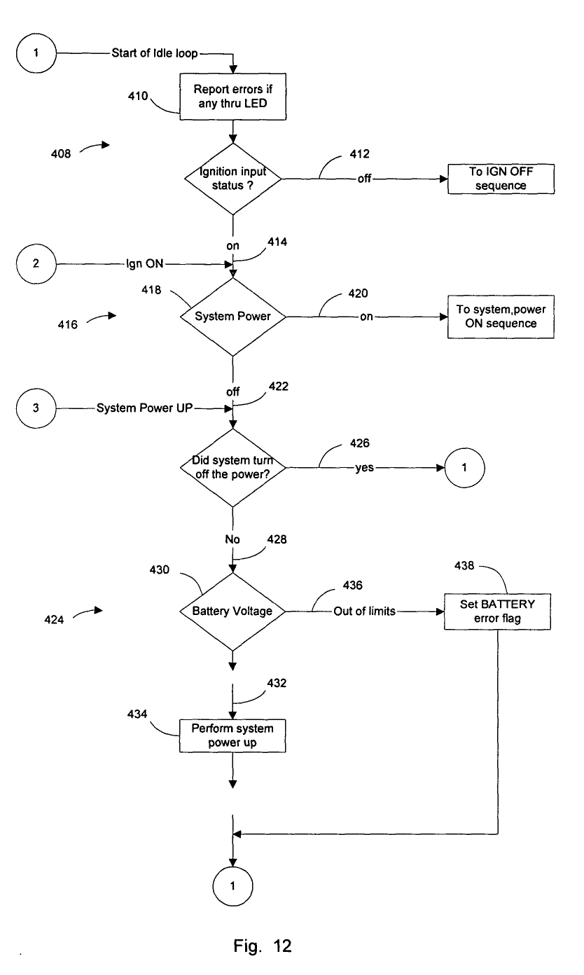

Referencing FIG. 12, the controller may be configured to detect low battery voltage when the ignition is on. To do so, the controller 132 initiates an idle loop 408 and reports any errors 410 through the signal output 156. Thereafter, if the ignition is off 412, then the controller 132 initiates a ignition off sequence 312. If the ignition is on 414, then the controller 132 initiates an ignition on sequence 416 by determining whether or not the system power is on 418. If so 420, then the controller 132 initiates a system power on sequence 270. If not 422, the controller 132 initiates a system power up sequence 424. If the system turned the power off 426, then the controller 132 returns to the idle sequence 200. If the system did not turn the power off 428, then the controller 132 checks the DC input power from the battery 430. If the input power is within limits 432, then the controller performs a system power up 434 and then returns to the idle loop 200. If the input power is not within the limits 436, then the controller sets a battery error flag 438 and returns to the idle loop 200.

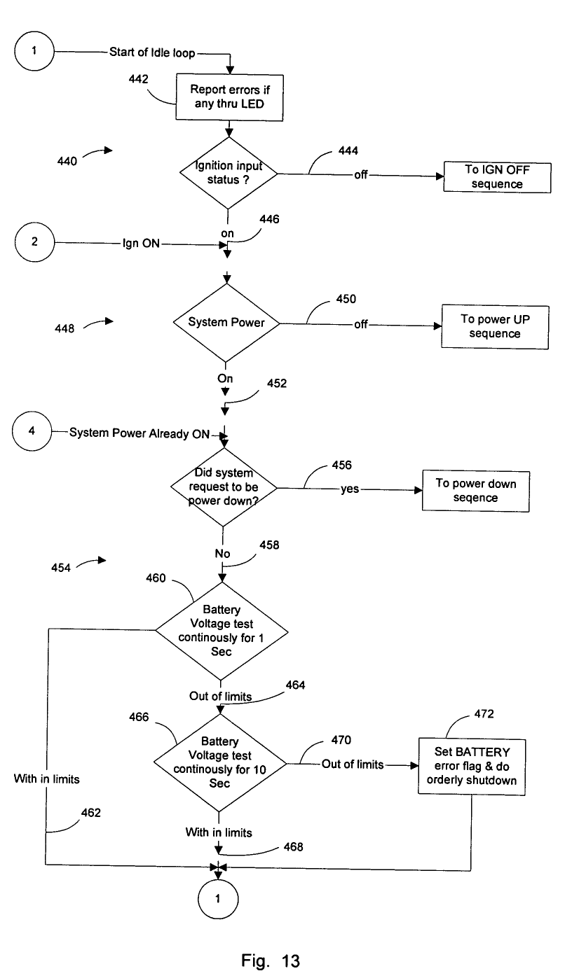

Referencing FIG. 13, in other embodiments the controller 132 may be configured to filter low DC input power from the battery 108 during engine cranking. For example, in an idle loop 440, after reporting any errors 442, the controller 132 goes to an ignition off sequence 312 if the ignition switch is off 444. If the ignition switch is on 446, then an ignition on sequence 448 is initiated. If the system power is off 450, then the controller 132 initiates a power up sequence 226. If the system power is on 452, then the controller initiates a system power already on sequence 454. If the system requested to be powered down 454, then the controller 132 goes to a power down sequence 264. If the system did not request to be powered down 458, then the controller 132 monitors the DC input power or voltage from the battery 460 for a predetermined amount of time (e.g., 1 second). If the voltage is within predetermined limits 462, then the controller 132 goes to the idle loop 200. If the voltage is not within limits 464, then the controller monitors the DC input voltage from the battery 466 for another predetermined amount of time (e.g., 10 seconds). If the voltage is within the limits 468, then the controller 132 goes to the idle loop 200. If the voltage is not within the limits 470, then the controller 132 initiates an orderly shutdown 472.

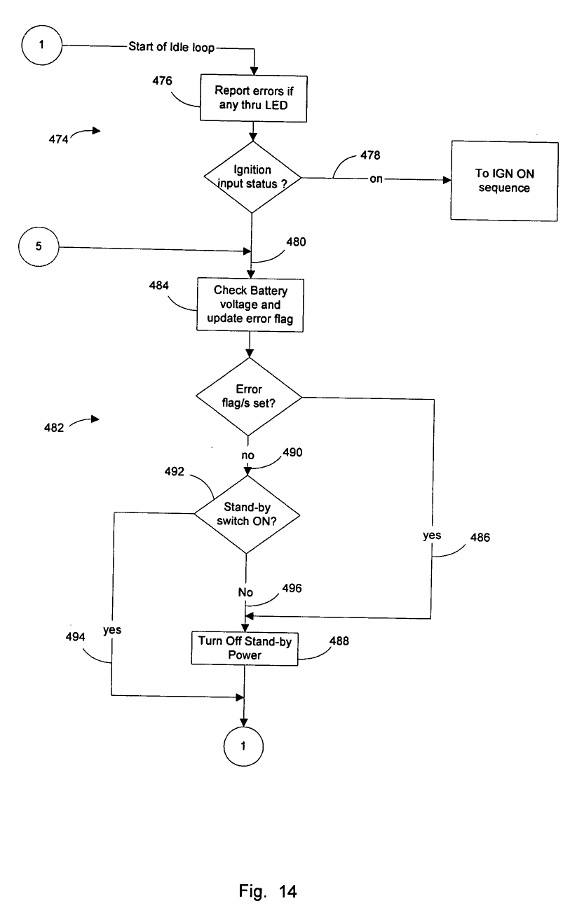

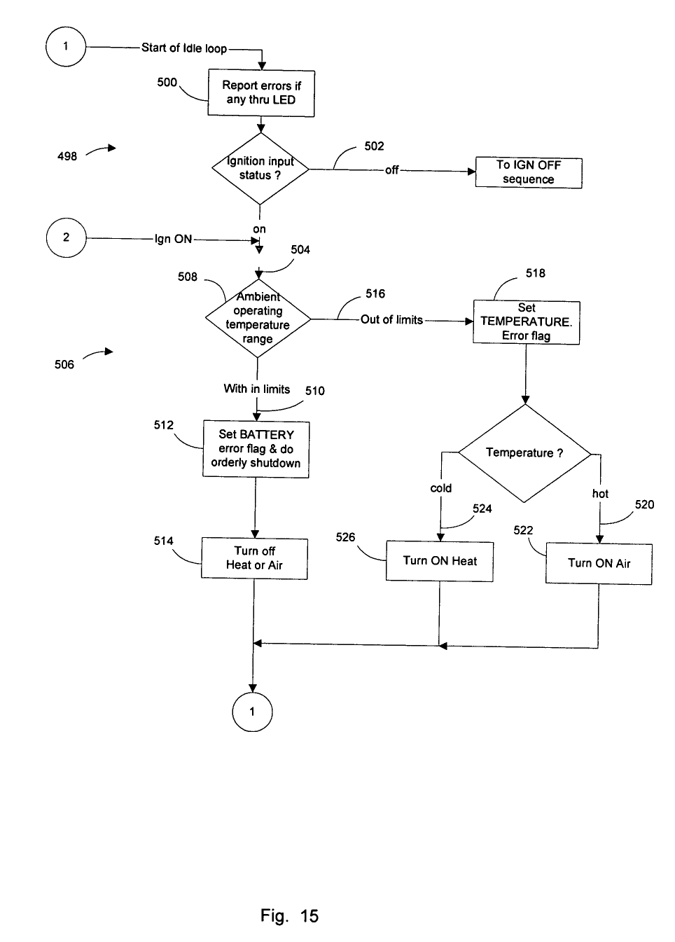

Referencing FIG. 14, the controller 132 may be configured to cut-off stand-by power during idle loops when low DC input power is detected from the battery 108. More specifically, the controller 132 initiates a ignition on sequence 206 after reporting errors 476 and if the ignition switch is on 478. If the ignition switch is off 480, then the controller 132 initiates an ignition off sequence 482. Initially, the controller 132 may check the DC input voltage from the battery and update any error flags 484. Thereafter, if any error flags are set 486, then the controller 132 turns off the stand-by power 488 and returns to the idle loop. If there are no error flags set 490, the controller checks to see if the stand-by switch is on 492. If so 494, the controller 132 goes to the idle loop. If not 496, the controller 132 turns off the stand-by power 488.

Referencing FIG. 15, in other embodiments the controller 132 is configured to control the temperature of the system 104. For example, in an idle loop 498 the controller 132 initiates a ignition off sequence 312 after reporting errors 500 and if the ignition switch is off 502. If the ignition switch is on 504, the controller 132 initiates an ignition on sequence 506. The controller then monitors the ambient operating temperature 508. If the temperature is within limits 510, then the controller turns off the heat or air 512 and performs a normal power up sequence 514. If the temperature is out of limits 516, then the controller sets a temperature error flag 518. If the temperature is too hot 520, then the controller 132 turns on the air 522 and returns to the idle sequence. If the temperature is too cold 524, then the controller 132 turns on the heater 526.

Those skilled in the art will understand that the preceding exemplary embodiments of the present invention provide the foundation for numerous alternatives and modifications thereto. These and other modifications are also within the scope of the present invention. Accordingly, the present invention is not limited to that precisely as shown and described above but by the scope of the appended claims.

What is claimed is:

1. A power supply for a motherboard operating in a vehicle including a motor, a battery, and an ignition, the motherboard including a soft power switch input and a power source input and having a power-up mode and a power-down mode, the power supply comprising:
a power input for connecting to the battery of the vehicle;
a switch input for connecting to the ignition of the vehicle;
a power output for connecting to the power source input of the motherboard;
a switch output for connecting to the soft power switch input of the motherboard;
a converter connected between the power input and the power output for converting DC input power from the battery to DC output power for the motherboard; and
a controller connected to the switch input and the switch output for causing:
the motherboard to initiate the power-up mode when the ignition of the vehicle is turned on; and
the motherboard to initiate the power-down mode when the ignition of the vehicle is turned off.

2. The power supply of claim 1 further comprising a plurality of power outputs and a plurality of converters;
each of the converters being connected between the power input and a respective one of the power outputs; and
each of the converters for converting DC input power from the battery to DC output power and for providing the DC output power to the respective one of the power outputs.

3. The power supply of claim 2 wherein at least one of the converters provides DC output power at a value that is different from the DC output power provided by the other converters.

4. The power supply of claim 2 wherein:
one of the converters provides DC output power at about +3.3 volts;
one of the converters provides DC output power at about +5 volts;
one of the converters provides DC output power at about +12 volts;
one of the converters provides DC output power at about −12 volts; and
one of the converters provides DC output power at about +5 volts stand-by.

5. The power supply of claim 2 wherein at least one of the power outputs is for connecting to a disk drive.

6. The power supply of claim 5 further comprising a temperature probe connected to the controller and for operatively connecting to the disk drive.

7. The power supply of claim 6 wherein the disk drive has a heater, the power supply further comprising:
a heater control output connected to the controller and for connecting to the heater of the disk drive;
the controller for monitoring the temperature of the disk drive.

8. The power supply of claim 7 wherein the controller activates the heater when the temperature of the disk drive falls below a threshold.

9. The power supply of claim 1 further comprising a signal output connected to the controller for indicating a status of the power supply.

10. The power supply of claim 8 wherein the signal output is a visual indicator.

11. The power supply of claim 1 further comprising a stand-by power switch connected between the converter and the power output.

12. The power supply of claim 1 wherein the controller enables the converter to provide DC output power.

13. A power supply for an electrical device operating in a vehicle including an electrical system with a battery, the electrical device including a power switch input and a power source input and following a power-up mode when turned on and a power-down mode when turned off, the power supply comprising:
a power input for connecting to the battery of the vehicle;
a switch input for connecting to the electrical system of the vehicle;
a power output for connecting to the power source input of the electrical device;
a switch output for connecting to the power switch input of the electrical device;
a converter connected between the power input and the power output for converting DC input power from the battery to DC output power for the electrical device; and
a controller connected between the switch input and the switch output for causing:
the electrical device to follow the power-up mode when the electrical system of the vehicle is activated; and
the electrical device to follow the power-down mode when the electrical system of the vehicle is deactivated.

14. The power supply of claim 13 wherein the electrical device is a computer, the controller for causing:
the computer to initiate the power-up mode when the electrical system of the vehicle is activated; and
the computer to initiate the power-down mode when the electrical system of the vehicle is deactivated.

15. The power supply of claim 13 wherein the vehicle is fuel-powered motorized vehicle wherein the electrical system includes an ignition system, the controller for causing:
the electrical device to follow the power-up mode when the ignition system of the vehicle is activated; and
the electrical device to follow the power-down mode when the ignition system of the vehicle is deactivated.

16. The power supply of claim 15 wherein the ignition system of the vehicle includes a switch, the controller for causing:
the electrical device to follow the power-up mode when the ignition switch is turned on; and
the electrical device to follow the power-down mode when the ignition switch is turned off.

17. A computer for operating in a vehicle having a battery and an ignition switch, the computer comprising:
a motherboard including a soft power switch input and a power source input and following a power-up mode when turned on and a power-down mode when turned off; and a power supply including:
a power input for connecting to the battery of the vehicle;
a switch input for connecting to the ignition switch of the vehicle;
a power output connected to the power source input of the motherboard;
a switch output connected to the power switch input of the motherboard;
a converter connected between the power input and the power output for converting DC input power from the battery to DC output power for the motherboard; and
a controller connected between the switch input and the switch output for causing:
the motherboard to follow the power-up mode when the ignition switch of the vehicle is turned on; and
the motherboard to follow the power-down mode when the ignition switch of the vehicle is turned off.

18. The computer of claim 17 wherein the motherboard is an ATX-compatible motherboard.

19. The computer of claim 17 further comprising a disk drive connected to the motherboard.

20. The computer of claim 19 wherein the disk drive has a power input, the power supply further including:
a drive power output connected to the power input of the disk drive; and
a drive converter connected between the power input and the drive power output for converting DC input power from the battery to DC output power for the motherboard.

21. The computer of claim 19 wherein the power supply further includes a temperature probe connected between the controller and the disk drive.

22. The computer of claim 21 wherein the disk drive has a heater, the power supply further comprising:
a heater control output connected between the controller and the heater of the disk drive;
the controller for monitoring the temperature of the disk drive.

23. The computer of claim 22 wherein the controller activates the heater when the temperature of the disk drive exceeds a threshold.

24. The computer of claim 17 wherein:
the motherboard further includes a power supply-on output and a power-good input; and
the power supply further includes a power supply-on input connected to power supply-on output of the motherboard and a power good output connected to the power-good input of the motherboard.

25. In combination, a vehicle and a computer, the combination comprising:
a vehicle including a motor, a battery, and an ignition switch; and
a computer having an operating system that follows a power-up mode when turned on and a power-down mode when turned off, the computer including:
a switch input connected to the ignition switch of the vehicle;
a converter connected to the battery of the vehicle for converting DC input power from the battery to DC output power for the computer; and
a controller connected to the switch input for initiating:
the power-up mode of the computer when the ignition switch of the vehicle turned on; and
the power-down mode of the computer when the ignition switch of the vehicle is turned off.

26. A method for controlling a computer installed in a vehicle, the computer following a power-up mode when turned on and a power-down mode when turned off, the vehicle having a battery and an ignition system, the method comprising:
automatically initiating the power-up mode when the ignition system is activated; and
automatically initiating the power-down mode when the ignition system is deactivated.

27. The method of claim 25 further comprising:
converting DC power from the battery to DC power for the computer.

28. A method for installing a motherboard in a vehicle having a battery and an ignition system, the motherboard including a soft power switch input and a power source input and following a power-up mode when turned on and a power-down mode when turned off, the method comprising:
providing a power supply including a power input, a switch input, a power output, a switch output connected, a converter connected between the power input and the power output for converting DC input power from the battery to DC output power for the motherboard, and a controller connected between the switch input and the switch output for causing:
the motherboard to follow the power-up mode when the ignition switch of the vehicle is turned on; and
the motherboard to follow the power-down mode when the ignition switch of the vehicle is turned off;
connecting the power input of the power supply to the battery of the vehicle;
connecting the switch input of the power supply to the ignition switch of the vehicle;
connecting the power output of the power supply to the power source input of the motherboard; and
connecting the switch output of the power supply to the power switch input of the motherboard.
